(19) United States
(12) Patent Application Publication
(10) Pub. No.: US 2002/0181383 A1
(43) Pub. Date: Dec. 5, 2002

(54) Compatible optical pick-up device

(76) Inventors: Pyong-Yong Seong, Seoul (KR); Ju-hyung Lee, Gyeonggi-do (KR); No-jun Kwak, Gyeonggi-do (KR); Kun-soo Kim, Seoul (KR); Jong-ryull Kim, Gyeonggi-do (KR)

Correspondence Address: STAAS & HALSEY LLP, 700 11TH STREET, NW, SUITE 500, WASHINGTON, DC, 20001, US

(21) Appl. No.: 10/120,787

(22) Filed: Apr. 12, 2002

(30) Foreign Application Priority Data
Apr. 13, 2001 (KR) 2001-19942

(51) Int. Cl. G11B 7/135

(52) U.S. Cl. 369/112.17

(57) ABSTRACT

A compatible optical pick-up device includes a first light source to emit a first light, a second light source to emit a second light and having a wavelength that is different from that of the first light, a first optical path converter to reflect the first light irradiated from the first light source onto an optical path, a second optical path converter to reflect the first light from the first optical path converter and transmit the second light irradiated from the second light source onto the optical path, an objective lens to converge the light received from the second optical path converter towards an optical recording medium, and a photo-detector to receive an incident light reflected by the optical recording medium. The compatible optical pick-up device reduces the difference between transmissivities depending on the polarization status of the incident light by adopting a transmission-type optical path converter such that the optical recording medium is minimally affected by the birefringence.

### CROSS-REFERENCE TO RELATED APPLICATION

This application claims the benefit of Korean Application No. 2001-19942, filed Apr. 13, 2001, in the Korean Intellectual Property Office, the disclosure of which is incorporated herein by reference.

### BACKGROUND OF THE INVENTION

1. Field of the Invention

The present invention relates to a compatible optical pick-up device, and more particularly, to a compatible optical pick-up device that obtains a more reliable reproduction signal by allowing an optical disc to be minimally affected by birefringence and light reflected back from the optical disc.

2. Description of the Related Art

Theoretically, an optical disc with a substrate made of a polycarbonate has an isotropic structure that ensures the same refractive index in all the directions. However, if the optical disc is subject to stress during a manufacturing process, the isotropy is not guaranteed. Thus, lack of the isotropic structure causes birefringence to incident light due to varying refractive indexes according to different directions. That is, the substrate of the optical disc is manufactured in an injection molding method. While a high temperature resin is injected into a mold and solidified in the injection molding stage, the optical disc is under elongation or compression stresses and birefringence occurs. If the birefringence occurs to the optical disc, a polarization characteristic of an optical element of an optical pick-up device changes a signal level. These changes in the signal level result in a deterioration of a reproduction signal.

With reference to FIG. 1, a conventional compatible optical pick-up device includes a first light source 10 and a second light source 20 which are placed at different positions. The first light source 10 emits light having roughly 650 nm wavelength. The second light source 20 emits light having roughly 780 nm wavelength light. The first light source 10 is used for a thin disc 50 such as a DVD, and the second light source 20 is used for a thick disc 52, such as a CD.

When the disc 50 is received, the light is emitted by the first light source 10 and is incident on a first beam splitter 15, is reflected by the first beam splitter 15, and then, travels towards the disc 50. Then, the light is reflected by the disc 50, is transmitted by the first beam splitter 15, and is received by a photo-detector 60. On a light path between the first beam splitter 15 and the disc 50, there are a reflection mirror 35, a collimating lens 40 and an objective lens 45. The reflection mirror 35 changes a path of the light irradiated from the first light source 10 and the second light source 20. The collimating lens 40 makes the light parallel. The objective lens 45 converges the incident light on the received one of the discs 50, 52.

In addition, when the disc 52 is received, the light is emitted from the second light source 20 and the emitted light passes through a grating 25 and is reflected by a second beam splitter 30. Then, the light is focused on the disc 52 after passing the reflection mirror 35, the collimating lens 40, and the objective lens 45. The light reflected by the disc 52 passes through the objective lens 45, the reflection mirror 35, the first beam splitter 15, and the second beam splitter 30, and is received by the photo-detector 60. A convergence lens 55 may also be positioned between the first beam splitter 15 and the photo-detector 60.

The first and second light sources 10 and 20 emit the light of a transverse electric (TE) mode that is a polarization mode. In the TE mode, p polarization vibrates in the direction that the semiconductor material layers making up the first and second light sources 10 and 20 are laminated, and s polarization vibrates in a horizontal direction. The light passes through the collimating lens 40 and the objective lens 45, and arrives at the received one of the discs 50, 52. As described above, if the isotropy of the discs 50, 52 is broken in the manufacturing process, the isotropy causes birefringence to the light and the discs 50, 52 have different refractive indexes depending on the status of the light polarization.

With reference to FIG. 2, a transmissivity (T) characteristic of the second beam splitter 30 will be described. For 650 nm wavelength light, almost the same transmissivity is maintained irrespective of polarization types. However, for 780 nm wavelength light, a large difference in transmissivities occurs depending on the s polarization and the p polarization. Ts and Tp indicate the transmissivities of the s polarization and the p polarization, respectively.

The polarization status and the birefringence direction of the light incident on the optical discs 50 and 52 change the intensity of the light amount, and further change the level of a signal received by the photo-detector 60. Since the reflection-type beam splitter shows a big gap between transmissivities depending on the polarization status, the level of the signal received by the photo-detector of the conventional compatible optical pick-up device changes due to the birefringence of the optical disc. Therefore, it is difficult to reproduce information normally.

In addition, the 780 nm wavelength light reflected by the thick disc 52 has a low transmissivity at the second beam splitter 30 as shown in FIG. 2. Therefore, the majority of the light is reflected and travels towards the second light source 20. Some of the reflected light impacts the light emitted by the second light source 20, which causes backtalk noise and deteriorates a jitter characteristic. The higher the operation speed of the optical disc, the worse the jitter characteristic. That is, the jitter characteristic does not impact seriously a reproduction performance of a general optical recording medium. However, since the influence of the jitter characteristic is serious on a high-speed optical recording medium, the jitter characteristic needs to be improved in order to keep up with the high speed of the optical recording medium.

### SUMMARY OF THE INVENTION

To solve the above-described and other problems, it is an object of the present invention to provide a compatible optical pick-up device that has an improved reproduction capability with an optical disc, is minimally affected by birefringence, and does not generate backtalk noise due to the light reflected from the optical disc.

Additional objects and advantages of the invention will be set forth in part in the description which follows and, in part, will be obvious from the description, or may be learned by practice of the invention.

To accomplish the above and other objects, there is provided a compatible optical pick-up device according to an embodiment of the invention that includes a first light source that emits a first light having a first wavelength, and a second light source that emits a second light having a second wavelength different from the first wavelength, a first optical path converter that reflects the first light received from the first light source onto an optical path to a received optical recording medium, and a second optical path converter that reflects the first light received from the first optical path converter and transmits the second light received from the second light source to follow the optical path, an objective lens that converges the first or second light received from the second optical path converter along the optical path towards the received optical recording medium, the received optical recording medium corresponding to the emitted one of the first and second light sources, and a photo-detector to receive an incident light which is reflected by the received optical recording medium and passes through the first optical path converter and the second optical path converter.

According to an aspect of the invention, the second optical path converter is a transmission-type beam splitter.

According to another aspect of the invention, the second optical path converter is a cubic-type beam splitter.

According to yet another aspect of the invention, the compatible optical pick-up device further includes a grating on the optical path between the first light source and the first optical path converter, or between the second light source and the second optical path converter.

According to still another aspect of the invention, the compatible optical pick-up device further includes a quarter wavelength plate on the optical path between the second light source and the second optical path converter.

### BRIEF DESCRIPTION OF THE DRAWINGS

The above and other objects and advantages of the present invention will become more apparent and more readily appreciated by describing in detail embodiments thereof with reference to the accompanying drawings in which:

FIG. 1 shows a conventional compatible optical pick-up device;

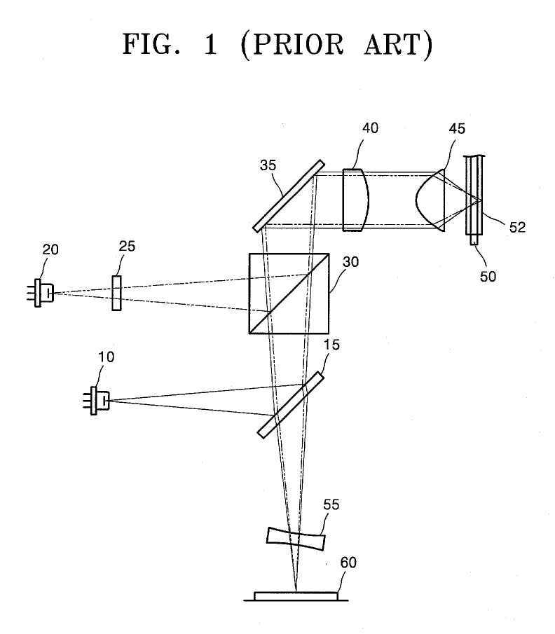

FIG. 2 is a graph showing transmissivities of a second beam splitter of the conventional compatible optical pick-up device depending on p polarization and s polarization;

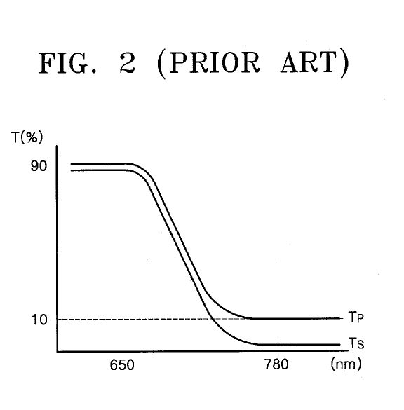

FIG. 3 shows an optical pick-up device according to an embodiment of the present invention;

FIG. 4 shows a compatible optical pick-up device according to another embodiment of the present invention;

FIG. 5 is a graph showing transmissivities of a second optical path converter of the compatible optical pick-up device according to the present invention depending on p polarization and s polarization;

FIG. 6 shows a compatible optical pick-up device according to a further embodiment of the present invention.

### DETAILED DESCRIPTION OF THE EMBODIMENTS

Reference will now be made in detail to the present preferred embodiments of the present invention, examples of which are illustrated in the accompanying drawings, wherein like reference numerals refer to the like elements throughout. The embodiments are described below in order to explain the present invention by referring to the figures.

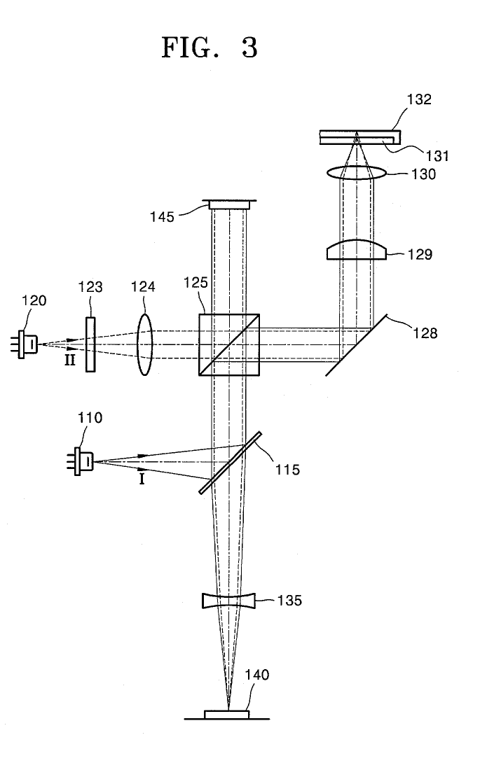

With reference to FIG. 3, a compatible optical pick-up device according to an embodiment of the present invention includes a first light source 110 that emits a first light (I), and a second light source 120 that emits a second light (II). The second light (II) has a wavelength that is shorter than a wavelength of the first light (I). A first optical path converter 115 reflects the first light (I) received from the first light source 110. A second optical path converter 125 transmits the second light (II) received from the second light source 120, and reflects the first light (I) received from the first optical path converter 115. An objective lens 130 focuses the light received from the second optical path converter 125 onto the received one of the optical recording media 131 and 132, respectively, so as to record and/or reproduce data with respect to the received optical recording medium 131 or 132.

The optical pick-up device according to the present invention includes the first light source 110 that emits the first light (I) to record/reproduce data with respect to the first optical disc 131, and the second light source 120 that emits the second light (II) to record/reproduce data with respect to the second optical disc 132 so that optical discs 131 and 132 of different formats can be compatibly used. While shown as received together, it is understood that the first and second optical discs 131,132 are generally received individually. Further, while the first and second light beams (I) and (II) are shown emitted together, the first and second light beams (I) and (II) are generally emitted separately.

The first light (I) and the second light (II) have different wavelengths. For example, the optical recording media 131 and 132 are optical discs with different thickness. The relatively thin optical disc is a DVD 131 while the relatively thick optical disc is a CD 132 according to an embodiment of the invention. In that case, the first light (I) has a 650 nm wavelength while the second light (II) has a 780 nm wavelength.

The first light (I) is reflected by the first optical path converter 115 and travels towards the objective lens 130 after being reflected by the second optical path converter 125. As shown, the objective lens 130 is optimized for the wavelength of the first light (I) and the thickness of the relatively thin optical disc 131. However, it is understood that this optimization is not required in all aspects of the invention. Further, there is a reflection mirror 128 and a first collimating lens 129. The reflection mirror 128 reflects the first light (I) so that the first light (I) travels towards the objective lens 130 and the first collimating lens 129 makes the light parallel. In addition, an external photo-detector 145 monitors the optical output of the first optical light source 110 and the second optical light source 120. However, it is understood that one or more of the reflection mirror 128, the first collimating lens 129, and the photo-detector 145 need not be used in all aspects of the invention.

The second light (II) is transmitted by the second optical path converter 125 and travels towards the reflection mirror 128, is focused on the relatively thick optical disc 132 after passing the first collimating lens 129 and the objective lens 130.

As described above, the first light (I) and the second light (II) are focused on the first optical disc 131 and the second optical disc 132, respectively, by the objective lens 130 after passing each of corresponding optical paths. The first light (I) and the second light (II) are reflected by the respective first optical disc 131 and the second optical disc 132. The reflected light is received by the photo-detector 140 after passing the objective lens 130, the reflection mirror 128, the second optical path converter 125 and the first optical path converter 115. Therefore, servo signals, such as a reproduction signal, a focusing error, and a tracking error are detected.

The second optical path converter 125 is a transmission-type beam splitter that transmits the majority of the second light emitted from the second light source 120 and reflects the first light emitted from the first light source 110. As shown, the second optical path converter 125 is a transmission-type cubic beam splitter. However, other types of beam splitters can be used.

In addition, a grating 123 is disposed on the optical path between the second light source 120 and the second optical path converter 125. The grating 123 is used in the detection of a tracking error signal using a 3-beam method, whereby the grating 123 diffracts incident light to make 3 beams. Between the grating 123 and the second optical path converter 125, there is further a second collimating lens 124 that enhances the optical efficiency of the second light (II). Moreover, an adjustment lens 135 detects a focus error signal by adjusting astigmatism between the first light (I) and the second light (II) which travel towards the photo-detector 140 after being reflected by the optical recording media 131 and 132. However, the grating 123 and the adjustment lens 135 need not be used in all aspects of the invention.

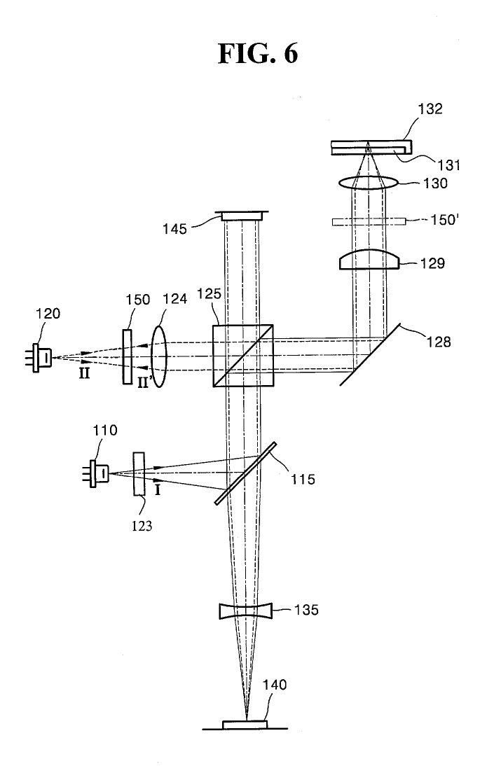

According to another embodiment of the present invention shown in FIG. 6, the grating 123 is on the optical path between the first light source 110 and the first optical path converter 115.

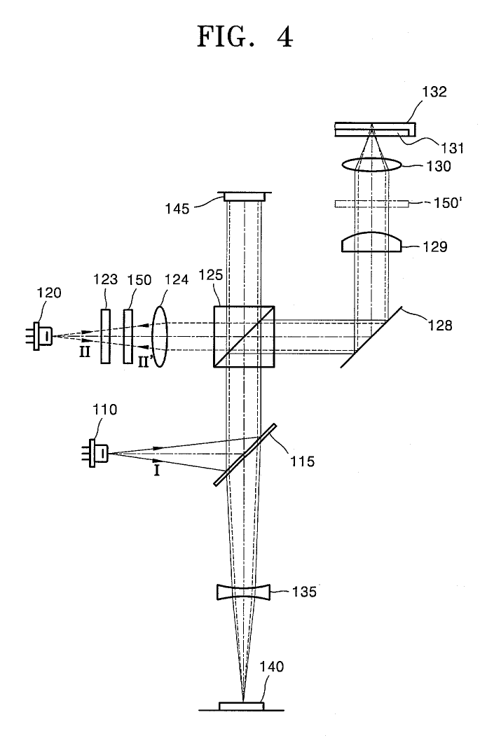

In addition, as shown in FIG. 4, a compatible optical pick-up device according to another embodiment of the present invention includes the first and second light sources 110 and 120 to emit the first light (I) and the second light (II), where the second light (II) has a different wavelength from a wavelength of the first light (I). The first and second optical path converters 115 and 125 reflect and/or transmit the first light (I) and the second light (II), and an objective lens 130 converges the light received from the second optical path converter 125 on corresponding optical recording media 131 and 132. A quarter wavelength plate 150 converts the polarization status of the light.

Here, the first light source 110, the second light source 120, the first optical path converter 115, the second optical path converter 125 and the objective lens 130 have the same reference numbers and the same functions as described above. Therefore, detailed explanation will be omitted.

The quarter wavelength plate 150 can be positioned on the optical path between the second light source 120 and the first optical path converter 125. The quarter wavelength plate 150′ can be positioned on the optical path between the reflection mirror 128 and the optical recording media 131 and 132 according to another embodiment of the invention.

As shown, the grating 123 is on the optical path between the second light source 120 and the second optical path converter 125. The grating 123 diffracts incident light to make three beams. If the quarter wavelength plate 150 is positioned between the second light source 120 and the second optical path converter 125, the quarter wavelength plate 150 and the grating 123 can be arranged separately or can be integrally formed.

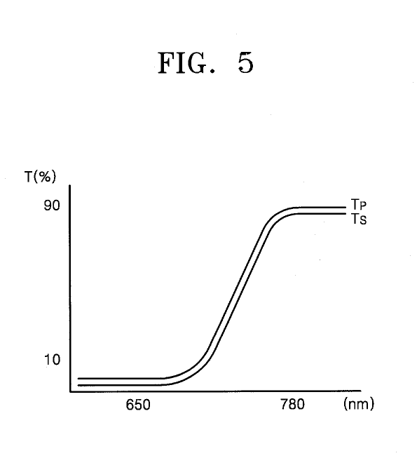

The operation of the compatible optical pick-up device according to the present invention will be described below. The second light (II) is emitted from the second light source 120 when the second recording medium 132 is be recorded and/or reproduced. The emitted second light (II) is received and transmitted by the second optical path converter 125. The transmitted second light (II) then travels towards the reflection mirror 128. The first light (I) is emitted from the first light source 110 when the first recording medium 131 is be recorded and/or reproduced. The emitted first light (I) is reflected by the first optical path converter 115. The reflected first light (I) is again reflected by the second optical path converter 125 towards the reflection mirror 128. Thus, the second optical path converter 125 is a transmission-type. The transmissivities (T) of the first light (I) and the second light (II) in the second optical path converter 125 are shown in FIG. 5.

For the shown embodiment, the second optical path converter 125 transmits 10% of the first light (I) with a 650 nm wavelength and transmits 90% of the second light (II) with 780 nm wavelength. Therefore, only about 10% of the first light (I) is transmitted by the second optical path converter 125 and the majority of the first light (I) is reflected towards the reflection mirror 128. The majority of the second light (II) is transmitted towards the reflection mirror 118.

As described above, the first light (I) and the second light (II) irradiated from the light sources 110, 120 are focused on the optical recording media 131 and 132, respectively, after passing through the objective lens 130 and then being reflected back. The reflected light beams (I) and (II) arrive at the second optical path converter 125 via the objective lens 130 and the reflection mirror 128. When the first light (I) is emitted, the majority of the first light is again reflected. When the second light (II) is emitted, the majority of the second light (II) is transmitted towards the second light source 120. The remaining portion of the second light (II) is reflected by the second optical path converter 125 towards the photo-detector 140. The first light (I) has a short wavelength and is used to record/reproduce the DVD, which is the relatively thin optical disc 131. The second light (II) has a long wavelength and is used to record/reproduce the CD, which is a relatively thick optical disc 132.

While less of the second light (II) is reflected as shown in FIG. 5, the second light (II) used for the relatively thick optical disc 132 requires a smaller amount of light during recording and/or reproduction than an amount of the first light (I) used for recording and/or reproduction of the relatively thin optical disc 131. Therefore, even though the second optical path converter 125 is a transmission type that reflects only a small amount of the second light (II), reproduction is not greatly affected. Instead, the amount of second light (II) emitted is adjusted so as to secure a sufficient amount of the light necessary for reproduction of the optical disc 132. That is, if more light is needed for reproduction of a relatively thick optical disc 132, the second light source 120 outputs the second light (II) at a high power.

As shown in FIG. 5, since the difference between the transmissivity Tp of the first light (I) and the transmissivity Ts of the second light (II) is not big, the optical recording media 131 and 132 can be minimally affected by the birefringence. Therefore, when reproduction is performed by the second light (II), a Radio Frequency (RF) signal is outputted evenly and an excellent reproduction signal can be obtained.

When the quarter wavelength plate 150 or 150′ is positioned on the optical path between the second light source 120 and the second optical path converter 125, or on the optical path between the optical recording media 131 and 132 and the reflection mirror 128 as shown in FIG. 4, how the light travels is described below. First, when the quarter wavelength plate 150 is positioned on the optical path between the second light source 120 and the second optical path converter 125, the majority of the second light (II) reflected by the second optical disc 132 is transmitted back to the second light source 120 because the transmissivity of the second optical path converter 125 is high for the second light (II). When the returned second light (II′) passes through the quarter wavelength plate 150, the polarization status of the light is changed. That is, the polarization of the returned second light (II′) is opposite to that of the second light (II) emitted from the second light source 120. Therefore, since the second light (II) emitted from the second light source 120 is not interfered by the second light (II′) returned from the second optical disc 132, back-talk noise does not occur. The faster the reproducing speeds used for the optical recording media are, the more serious the back-talk noise is. The back-talk noise has a bad influence on the reproduction performance.

The results of an experiment as to the effect on back talk is shown in Table 1.

TABLE 1

| | Speed | | | | | | |
|---|---|---|---|---|---|---|---|
| | Quarter wave- | 4 times | | 9 times | | 12 times | |
| | length plate | 3TL | 3TP | 3TL | 3TP | 3TL | 3TP |
| Jitter | Not applied | 18.4 | 20.6 | 23.6 | 20.5 | 23.9 | 25.0 |
| (average) | Applied | 19.2 | 20.0 | 23.4 | 17.7 | 19.7 | 17.3 |

Here, 3 T, L and P indicate a minimum mark length, a land and a pit respectively. As shown in Table 1, whether the quarter wavelength plate 50 is included or not, the faster the reproducing speeds of the optical recording media are, the bigger the difference between the average jitter values is. Therefore, if the present invention includes the quarter wavelength plate 150, the back-talk noise can be reduced and the jitter characteristic can be enhanced.

If the quarter wavelength plate 150 and the grating 123 are formed monolithically, a more compact optical pick-up device can be created and the yielding ratio can be increased. Further, the quarter wavelength plate 150′ can be positioned on the optical path between the objective lens 130 and the reflection mirror 128 as shown in FIG. 4.

While not shown, it is understood that the first light source 110 and the photo-detector 140 could be co-located in an emitter/detector unit. In such an embodiment, the first optical change converter 115 need not be used.

As described above, the compatible optical pick-up device according to the present invention reduces the difference between transmissivities depending on the polarization status of the incident light by using the transmission-type optical path converter such that the recording and/or reproduction with respect to optical recording media can be minimally affected by birefringence. Therefore, an excellent reproduction signal can be obtained.

In addition, the use of a quarter wavelength plate changes the polarization status of the light, and prevents interference between the light reflected by the optical recording media back to the light source and the light irradiated from the light source. As a result, the back-talk noise can be reduced.

Although a few preferred embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A compatible optical pick-up device comprising:
a first light source that emits a first light having a first wavelength corresponding to recording and/or reproduction with respect to a first optical recording medium;
a second light source that emits a second light having a second wavelength corresponding to recording and/or reproduction with respect to a second optical recording medium, the second wavelength being different from the first wavelength;
a first optical path converter that reflects the first light from said first light source onto an optical path;
a second optical path converter that reflects the first light received from said first optical path converter onto the optical path, and transmits the second light received from said second light source onto the optical path;
an objective lens disposed in the optical path to converge an emitted one of the first and second lights received from said second optical path converter towards a received one of the first and second optical recording media corresponding to the emitted one of the first and second lights; and
a photo-detector that receives an incident light reflected by the received optical recording medium and having passed through said objective lens, said first optical path converter, and said second optical path converter.

2. The compatible optical pick-up device of claim 1, wherein said second optical path converter is a transmission-type beam splitter.

3. The compatible optical pick-up device of claim 2, wherein said second optical path converter is a cubic-type beam splitter.

4. The compatible optical pick-up device of claim 3, further comprising a grating to split an incident one of the first and second lights, said grating being between said first light source and said first optical path converter, or between said second light source and said second optical path converter.

5. The compatible optical pick-up device of claim 4, further comprising a quarter wavelength plate to change a polarization status of the incident second light and disposed between said second light source and said second optical path converter.

6. The compatible optical pick-up device of claim 5, wherein said grating and said quarter wavelength plate are integrally formed as a common plate.

7. The compatible optical pick-up device of claim 5, wherein one of the first and second wavelengths is 650 nm, and the other of the first and second wavelengths is 780 nm.

8. The compatible optical pick-up device of claim 3, further comprising a quarter wavelength plate to change a polarization status of an incident one of the first and second lights and disposed on the optical path between said second optical path converter and the received optical recording medium.

9. The compatible optical pick-up device of claim 4, further comprising a quarter wavelength plate to change a polarization status of an incident one of the first and second lights and disposed on the optical path between said second optical path converter and the received optical recording medium.

10. The compatible optical pick-up device of claim 2, further comprising a grating to split an incident one of the first and second lights, said grating being between said first light source and said first optical path converter, or between said second light source and said second optical path converter.

11. The compatible optical pick-up device of claim 10, further comprising a quarter wavelength plate to change a polarization status of the incident second light and disposed between said second light source and said second optical path converter.

12. The compatible optical pick-up device of claim 11, wherein said grating and said quarter wavelength plate are integrally formed as a common plate.

13. The compatible optical pick-up device of claim 12, wherein one of the first and second wavelengths is 650 nm and the other of the first and second wavelengths is 780 nm.

14. The compatible optical pick-up device of claim 1, wherein said second optical path converter transmits roughly 90% or more of the second light emitted from said second light source, and reflects up to roughly 10% of the reflected second light received from said objective lens towards said photo-detector.

15. The compatible optical pick-up device of claim 14, wherein said second optical path converter reflects roughly 90% or more of the first light received from said first optical path converter and roughly 90% or more of the reflected first light received from said objective lens towards said photo-detector.

16. The compatible optical pick-up device of claim 15, further comprising a second photo-detector to monitor an optical output of said first and second light sources, said second photo-detector to receive from said second optical path converter:
a reflected portion of the second light emitted from said second light source and received by said second optical path converter, and
a transmitted portion of the first light received by said second optical path converter from said first optical path converter.

17. A compatible optical pick-up device to record and/or reproduce data with respect to first and second optical recording media, comprising:
a first light source that emits a first light having a first wavelength corresponding to recording and/or reproduction of the first optical recording medium;
a second light source that emits a second light having a second wavelength corresponding to recording and/or reproduction of the second optical recording medium, the second wavelength being different from the first wavelength;
an optical path converter that reflects the first light emitted from said first light source onto an optical path, and transmits the second light emitted from said second light source onto the optical path;
an objective lens disposed on the optical path to converge an emitted one of the first and second lights received from said optical path converter towards a received one of the first and second optical recording media corresponding to the emitted one of the first and second lights; and
a photo-detector that receives an incident light including portions of the first and second light having been reflected by the received optical recording medium and having passed through said objective lens and been reflected by said optical path converter.

18. The compatible optical pick-up device of claim 17, wherein said optical path converter transmits roughly 90% or more of the second light emitted from said second light source, and reflects a portion of the reflected second light received from said objective lens towards said photo-detector as the incident light.

19. The compatible optical pick-up device of claim 18, wherein said optical path converter reflects roughly 90% or more of the first light emitted from said first light source and reflects 90% or more of the reflected first light received from said objective lens towards said photo-detector as the incident light.

20. The compatible optical pick-up device of claim 19, wherein the portion of the received reflected second light reflected by said optical path converter towards said photo-detector is up to roughly 10% of the received reflected second light.

21. The compatible optical pick-up device of claim 19, further comprising a second photo-detector to monitor an optical output of said first and second light sources, said second photo-detector to receive from said optical path converter:
a non-transmitted portion of the second light emitted from said second light source and received by said optical path converter, and
a transmitted portion of the first light received by said optical path converter from said first light source.

22. The compatible optical pick-up device of claim 21, wherein the non-transmitted portion and the transmitted portion comprise up to 10% of the first and second lights received by said optical path converter from said first and second light sources.

23. The compatible optical pick-up device of claim 17, further comprising a quarter wavelength plate disposed between said second light source and the received optical recording medium, said quarter wavelength plate to change a polarization of incident light such that the second light emitted from said second light source does not interfere with the second light reflected from the received optical recording medium.

24. The compatible optical pick-up device of claim 23, wherein said quarter wavelength plate is disposed between said second light source and said optical path converter.

25. The compatible optical pick-up device of claim 23, wherein said quarter wavelength plate is disposed between said objective lens and said optical path converter.

26. The compatible optical pick-up device of claim 19, wherein the first wavelength is at or below 650 nm, and the second wavelength is at or above 780 nm.

27. The compatible optical pick-up device of claim 19, wherein the portion of the reflected second light received by said optical path converter from said objective lens and reflected towards said photo-detector comprises up to 10% of the received reflected second light.

28. The compatible optical pick-up device of claim 19, further comprising a monolithic piece disposed between said second light source and said optical path converter, wherein:
said monolithic piece comprises a quarter wavelength portion and a grating portion,
the quarter wavelength portion changes a polarization of the second light such that the second light emitted from said second light source does not interfere with the second light reflected from the received optical recording medium, and
the grating portion split the incident second light.

29. The compatible optical pick-up device of claim 25, further comprising a mirror disposed between said objective lens and said optical path converter and changes the optical path by reflecting the first and second lights prior to and after being reflected by the received optical recording medium, wherein said wavelength plate is disposed between said objective lens and said mirror.

30. A compatible optical pick-up device to record and/or reproduce data with respect to first and second optical recording media, comprising:
a first light source that emits a first light having a first wavelength corresponding to recording and/or reproduction of the first optical recording medium;
a second light source that emits a second light having a second wavelength corresponding to recording and/or reproduction of the second optical recording medium, the second wavelength being different from the first wavelength;
an optical path converter that receives and guides portions of the first and second lights onto an optical path to a received one of the first and second optical recording media, said optical path converter transmits one of the first and second lights such that a difference in transmissivities of s and p type polarizations of the first light due to birefringence caused by the first optical recording medium is roughly equal to a difference in transmissivities of s and p type polarizations of the second light due to birefringence caused by the second optical recording medium;
an objective lens disposed on the optical path to converge an emitted one of the first and second lights received from said optical path converter towards a received one of the first and second optical recording media corresponding to the emitted one of the first and second lights; and
a photo-detector that receives an incident light including portions of the first and second light having been reflected by the received optical recording medium and having passed through said objective lens and been guided by said optical path converter.
